(19) United States
(12) Patent Application Publication
(10) Pub. No.: US 2003/0150998 A1
(43) Pub. Date: Aug. 14, 2003

(54) Device and method for ultraviolet radiation monitoring

(76) Inventors: Minseub Shin, Shoreview, MN (US); Anil K. Jain, North Oaks, MN (US)

Correspondence Address: MERCHANT & GOULD PC, P.O. BOX 2903, MINNEAPOLIS, MN, 55402-0903, US

(21) Appl. No.: 10/257,457

(22) PCT Filed: Apr. 27, 2001
(86) PCT No.: PCT/US01/13689

(30) Foreign Application Priority Data
Apr. 28, 2000 (US) 60200459

(51) Int. Cl. G01J 1/44

(52) U.S. Cl. 250/372

(57) ABSTRACT

An ultraviolet radiation monitor is disclosed. The monitor includes an aluminum gallium nitride-based detector, such as a Schottky junction fabricated with aluminum gallium nitride and a Schottky layer containing palladium, and a processor. The composition of the detector is tailored so that the detector is responsive substantially only to radiation of certain wavelengths, such as UV-B. The processor is adapted to receive user input of the user's skin type and ultraviolet-blocking power of any sunscreen the user is wearing. The processor is also adapted to read the signal generated by the detector and calculate the intensity of the ultraviolet radiation received by the detector. The processor is further adapted to calculate the maximum length ultraviolet exposure time for the user, based on the radiation intensity, skin type and sunscreen information.

This application is being filed as a PCT International Patent application in the name of APA Optics, Inc., a U.S. national corporation (applicant for all countries except the U.S.), and in the names of Minseub Shin, a citizen of the Republic of Korea (South Korea), and Anil K. Jain, a U.S. citizen (applicants for the U.S. only), on Apr. 27, 2001, designating all countries.

### BACKGROUND OF THE INVENTION

1. Field of the Invention

The invention relates generally to monitoring ultraviolet radiation and more specifically to monitoring UV radiation using aluminum gallium nitride detectors.

2. Description of the Related Art

Ultraviolet radiation (UV) detectors are useful in a variety of applications. For example, UV radiometers are used to detect UV radiation from the sun to assist users engaged in outdoor activities in setting time limits for exposure to the sunlight. In manufacturing processes where epoxy is used, UV radiometers are often used to monitor the UV radiation intensity from UV lamps to determine the proper length of time for curing epoxy. UV detectors are also useful in flame sensing and missile guidance systems.

In certain applications, it is advantageous or necessary to use UV detectors that have spectral selectivity, i.e., sensor that are sensitive only to radiation of certain wavelength but not of others. In flame sensing, for example, it is often desirable to employ visible-blind UV detectors, i.e., those sensitive to UV but not to radiation of longer wavelengths. This is because in some applications, flames are to be detected against hot backgrounds such as infrared emissions from hot bricks in a furnace. By detecting only UV emissions, which are present in the flames but not in the hot backgrounds, one can distinguish flames from the backgrounds.

For sunburn prevention, it is also desirable to selectively measure UV radiation of wavelengths of 320 nanometers (nm) or shorter. Most of the sun's UV radiation of wavelengths shorter than 290 nm (often called “UV-C”) does not reach the earth's surface due to the absorption by the earth's ozone layer. Of the remainder, UV radiation of wavelengths between 290 nm and 320 nm (“UV-B”) is known to be particularly harmful to humans. Thus, it is desirable to accurately monitor UV-B instead of radiation of a broad spectrum.

For sunburn prevention applications, it is also desirable to have a convenient way to set accurate dosage limits and alert the user when the limits are reached.

Conventional devices and methods have not adequately addressed these and other needs.

### SUMMARY OF THE INVENTION

According to the invention, an ultraviolet radiation monitor includes (a) an aluminum gallium nitride detector configured to produce an intensity signal indicative of the intensity of the ultraviolet radiation received by the detector; (b) signal generator configured to produce a skin type signal indicative of a level of tolerance by a person's skin to ultraviolet radiation; (c) a signal generator configured to produce a blocking power signal indicative of the blocking power of a sunscreen applied to the skin of the person; and (d) a processor operatively connected to, and receiving signals from, the detector, and the signal generators signal generator to receive the intensity signal, skin type signal and blocking power signal. The processor is configured to generate, in response to the skin type signal and blocking power signal, a dose limit signal indicative of a limit of the cumulative ultraviolet radiation the person is to receive and, in response to the intensity signal, a cumulative dosage signal indicative of the cumulative ultraviolet radiation the person has received over a time period. The processor is also configured to produce a signal, such as an alarm or visual display, perceptible to the user when the cumulative ultraviolet radiation indicated by the dosage signal is at least the limit indicated by the dose limit signal.

The signal generators can include user interfaces to receive user inputs indicative of the level of tolerance by a person's skin to ultraviolet radiation and indicative of the blocking power of the sunscreen applied to the skin of the person.

The ultraviolet radiation monitor can include a housing accommodating the signal generators, processor and user interfaces, with the housing being in the form of a wrist watch.

The detector used in the ultraviolet radiation monitor can have a spectral response in which the magnitude of response changes by at least an order of 1,000 between 300 nm and 330 nm. The spectral response can substantially match the erythemal response spectrum. The detector can be a Schottky-barrier junction detector. It can further be a junction in which one electrode is made substantially of AlₓGa₁₋ₓN, with x not less than about 25% and not more than about 30%, or not less than about 27% and not more than about 29%.

The processor in the ultraviolet radiation monitor can be configured to generally continuously receive from the detector intensity signals over the time period and produce a dosage signal indicative of the time integral over the time period of the ultraviolet radiation intensity. The processor can also be configured to receive from the detector an intensity signal and produce a dosage signal indicative of product of the intensity and the length of the time period.

The ultraviolet radiation monitor can include a substantially flat display surface configured to show a variety of signals produced by the various components of the monitor, and the detector can have a directional variation in the response in which there is a direction in which the radiation flux causes the maximum response by the detector. This direction can be at a non-zero angle, for example 40°, from the orientation of the display surface.

A method for aiding a person to prevent over exposure to ultraviolet radiation according to the invention includes (a) measuring the intensity of the ultraviolet radiation using a ultraviolet radiation detector at least partially fabricated from aluminum gallium nitride; (b) ascertaining the level of tolerance by the person's skin to ultraviolet radiation; (c) ascertaining the blocking power of any sunscreen applied to the skin of the person; (d) deriving from the tolerance level and blocking power a limit of the cumulative ultraviolet radiation the person is to receive; (e) calculating, based at least partially on the measured ultraviolet radiation intensity, the cumulative ultraviolet radiation the person has received over a time period; and (f) alerting the use, for example by alarm or a visual display, when the cumulative ultraviolet radiation is at least the limit of the cumulative ultraviolet radiation the person is to receive.

The method can also include selecting, without using spectral filters, the spectral response of the detector such that the magnitude of response of the detector to ultraviolet radiation changes by at least an order of 800, or between 800 and 1200, or about 1000, between 300 nm and 330 nm. The selection can be accomplished by setting the composition of the aluminum gallium nitride used in the detector, for example, by constructing the detector with a Schottky-barrier junction detector in which one electrode is made substantially of AlₓGa₁₋ₓN, wherein x is not less than about 25% and not more than about 30%, or not less than about 27% and not more than about 29%.

### BRIEF DESCRIPTION OF THE DRAWINGS

Other objects and advantages of the invention will become apparent upon reading the following detailed description and upon reference to the drawings in which:

FIG. 1 shows the erythemal response spectrum of human skin;

FIG. 2 shows the spectral response of a UV detector constructed with aluminum gallium nitride of an approximate composition of Al_{0.26}Ga_{0.74}N;

FIG. 3 shows a watch-type UV radiation monitor as an illustrative embodiment of the invention;

FIG. 4 shows a cross-sectional view of the UV radiation monitor shown in FIG. 3;

FIG. 5 shows a schematic diagram of the electrical circuit for a UV radiation monitor in one illustrative embodiment of the invention;

FIG. 6 shows a more detailed diagram of the micro control unit;

FIG. 7 shows the main steps in an illustrative process in accordance with one aspect of the invention; and

FIGS. 8A-8C shows the structure of a UV radiation detector in accordance with one aspect of the invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

The UV-monitoring device and method of the invention are particularly useful for monitoring the UV radiation most harmful to human skin. They provide sensitive and accurate UV measurements by using aluminum gallium nitride detectors with tailored composition and UV dosage limit warning signals based on calculations that take into account user skin type and UV-blocking power of any sunscreen the user is using.

On average, how long a person may be safely exposed to UV radiation is determined by a number of factors. First, the safe exposure time, i.e., the amount of time a person can stay in the solar UV radiation without skin damage, is inversely proportional to the intensity of the UV radiation, often expressed as “UV-index” (“UVI”) for solar UV. Second, the tolerance of UV radiation by an individual is related to that individual's skin type, which may be quantified as a numeric “skin factor” (“SF”), devised by the American Dermatological Association. Other factors being equal, the higher the SF of a person, the longer the person can be exposed to UV radiation. Specifically, if a person's SF is incremented by one, the safe exposure time of the person is lengthened by a factor of about 1.22. Third, a sunscreen typically enables a person to be safely exposed to UV radiation longer. The “Sun Protection Factor” (“SPF”) of a sunscreen denotes the factor by which the sun exposure time may be lengthened. For example, a sunscreen with an SPF of 15 enables the person wearing the sunscreen to stay out in the sun 15 times the length of time that person can be subjected to the same UV condition without the protection of the sunscreen.

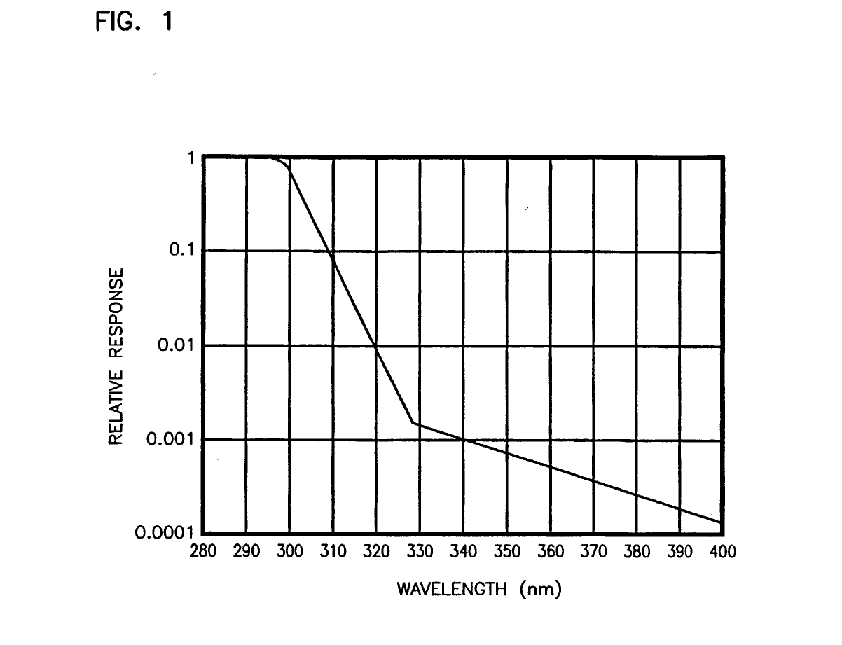

In measuring UV radiation intensity for sunburn protection, it is important to measure the portions of UV radiation that is harmful to humans. In general, human skin is much more sensitive to UV-B than to UV-A. As shown in FIG. 1, known as the “erythemal response spectrum”, the human skin sensitivity to erythema (redness or burning due to UV exposure) typically undergoes a increase of several decades when the wavelength is decreased from about 330 nm to 300 nm. Thus, to accurately measure harmful UV radiation, it is preferable to have a detector that has a spectral response that closely matches the erythemal response spectrum, at least in the range of about 290 nm to about 350 nm.

Although specific spectral responses of monitors may be achieved by a combination of UV detectors and filters, it is often costly to use the number of filters needed. In addition, the efficiency of the monitor is compromised because of the energy losses in the filters. Photomultipliers may be used for some of these applications but unfortunately are bulky, difficult to integrate with control electronics and, in general, require high operating voltages.

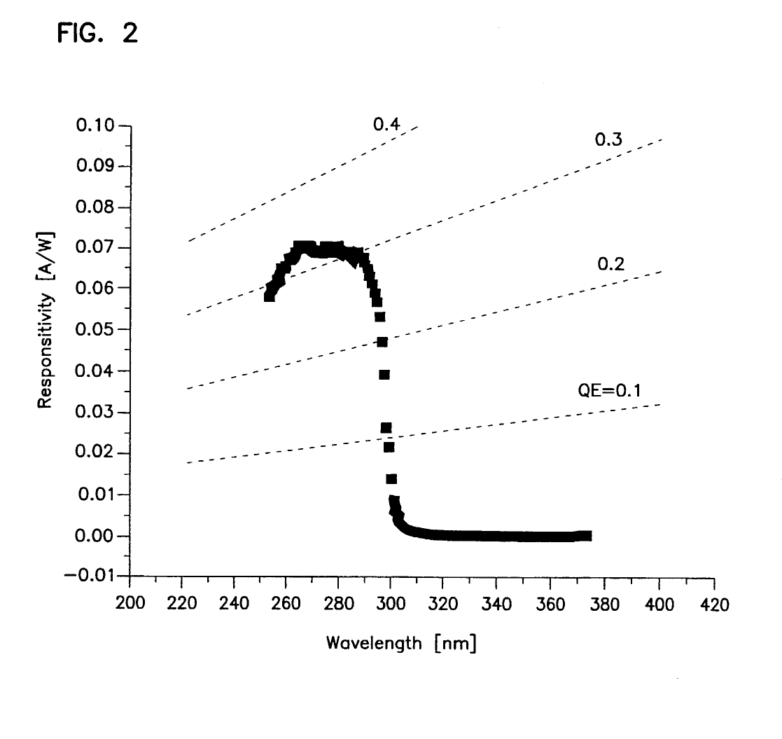

The use of detectors made of aluminum gallium nitride addresses these problems. Aluminum gallium nitride, AlₓGa₁₋ₓN, where x ranges from 0 to 1, is a compound semiconductor that is ideally suited for devices in the ultraviolet parts of the spectrum. Aluminum gallium nitride has a direct band gap which is tunable from 3.4 electron volts (or 365 nm) at x=0 to 6.2 electron volts (or 200 nm) at x=1, by adjusting the composition, i.e., the value of x. This makes the material ideally suited for intrinsic ultraviolet sensors with high responsivities for wavelengths shorter than 365 nanometers and essentially no photosensitivity for longer wavelengths. For example, Schottky-barrier detectors fabricated from aluminum gallium nitride (including the end-members AlN and GaN) for visible-blind UV detection have been disclosed in the U.S. Pat. No. 6,104,074, which is commonly assigned with the present application and is incorporated herein by reference. The spectral response (FIG. 2), for example, of a detector fabricated with the approximate composition Al_{0.26}Ga_{0.74}N and in photovoltaic mode exhibits a cut-off at about 290 nm, which is the Al_{0.26}Ga_{0.74}N band edge, with the responsivity falling off by orders of magnitude for longer wavelengths.

The spectral response of the aluminum gallium nitride detector can be designed to closely match the erythemal response spectrum, i.e., to have an onset of the drop in responsivity at about 290 to 300 nm and a drop of responsivity of at least 800, for example between 800 and 1,200 or about 1,000, between 300 nm and 330 nm. For example, with an approximate composition Al_{0.26}Ga_{0.74}N, the detector has responsivity that decreases by a factor of about 1000, between wavelengths of 300 nm and 330 nm. The spectral response of the detector is otherwise also similar to the erythemal response spectrum at least between about 290 nm and 350 nm wavelengths.

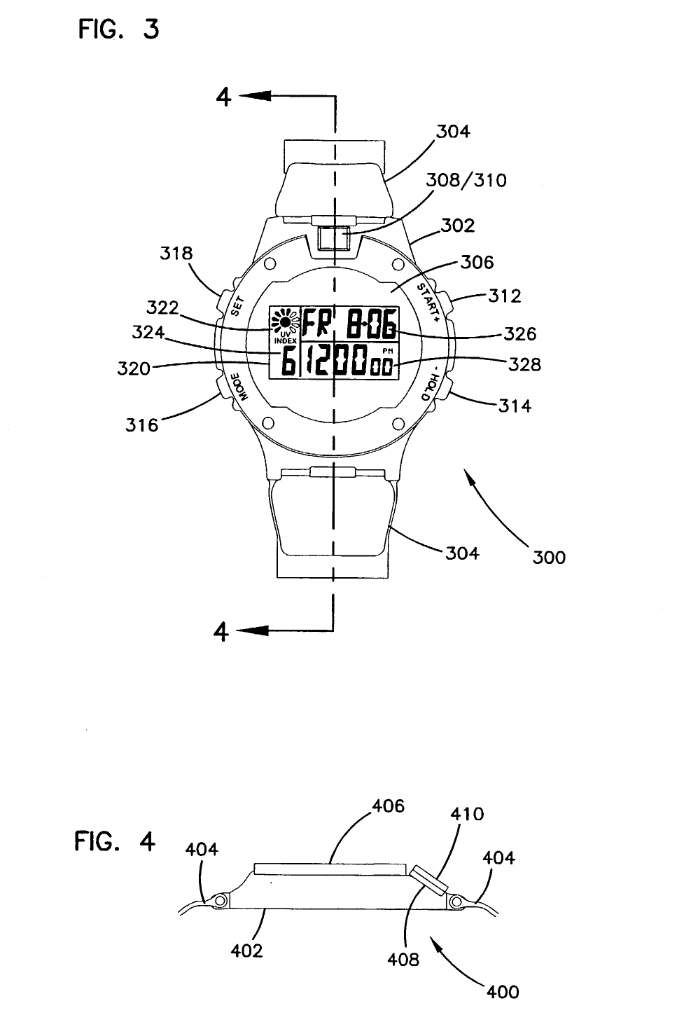

As shown in FIG. 3, the UV radiation monitor 300 includes a housing 302, which can be of any suitable housing, including a wrist-watch-type housing having a watchband 304 for attaching the monitor 300 to a person.

The monitor 300 also includes a UV radiation detector 308 adapted to be exposed to UV radiation through the housing 302. The detector 308 is of a photo-electrical type that has an intrinsic (i.e., without the aid of filters) spectral response limited to UV radiation. For example, the detector 308 can be a junction device having aluminum gallium nitride on one side of the junction. More specifically, the detector 308 can include a Schottky-barrier junction detector such as those disclosed in the U.S. patent application Ser. No. 09/206,328, as incorporated herein above. In particular, the composition of aluminum gallium nitride can be chosen, such that the detector 308 is sensitive substantially only to UV-B radiation. Experiments have shown that detectors with a composition with x of about 25-30% have such characteristics. For example, a composition of x of about 27-29% results in a detector that is has a spectral response cutoff, i.e., the point where the responsivity drops to 10% of peak responsivity, at about 320 nm.

The detector 308 can further be of a type that has a spectral response approximately matching the spectral sensitivity of the human skin, i.e., the erythemal response spectrum. That is, the percentage decrease in the detector response to radiation as a function of radiation frequency around the cutoff wavelength is approximately the same as the percentage decrease in erythemal response spetrum. For example, a composition with x of about 27% to about 29% results in a detector that is has a spectral response that drops off by a factor of about 1000 between wavelengths of 300 nm and 330 nm.

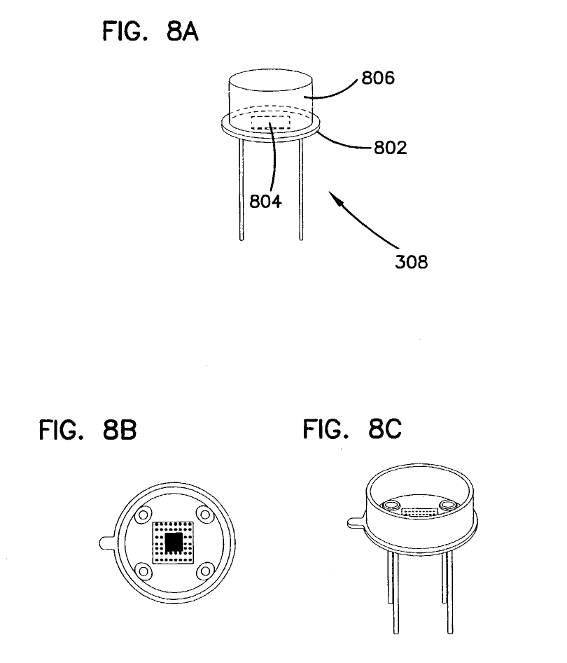

An example of this type of device is shown in FIG. 8A. The detector 308 includes a detector housing 802, which contains a Schottky-barrier junction 804 that is sensitive substantially only to radiation with wavelengths of 320 nm or shorter, as described above. The junction 804 is covered with a layer of a UV-transparent epoxy 806, the spectral response of which is such that the combination of the epoxy with the junction 804 results in a spectral response that approximately matches the spectral sensitivity of the human skin. An example is the Epo-Tek 301-2 epoxy, available from Epoxy Technology, Inc., Boston Mass. This epoxy is 98-99% transparent at wavelengths from 310 nm to 2.5 μm and 90% transparent at 300 nm but rapidly becomes opaque at wavelengths shorter than 290 nm. Thus the combination of the junction 804 and epoxy layer 808 is sensitive substantially only to radiation with wavelengths between 290 and 320 nm, i.e., UV-B, and the spectral response approximately matches the spectral sensitivity of human skin. FIGS. 8B and 8C illustrates the detector 308 in further details.

Aluminum gallium nitride UV detectors can be made by a variety of known techniques, including those disclosed in the U.S. Pat. No. 6,104,074 for Schottky-barrier detectors, as mentioned above, and U.S. Pat. No. 5,278,435, which is also incorporated herein by reference.

As shown in FIG. 4, the detector 408 (308 in FIG. 3) can be covered by a protective cover 410 (310 in FIG. 3). The protective cover 410 can be of any UV-transparent material, including a visible-blocking, UV-transparent color filter such as those commercially available from Corning, Inc., Corning, N.Y. Although aluminum gallium nitride based detectors exhibit excellent rejection ratio of the visible range (better than 1000:1), a color filter can further improve that performance.

The housing 302 accommodates a number of pushbuttons, including the START+ button 312, HOLD− button 314, MODE button 316 and SET button 318. These buttons, when pushed, operate their respective switches 312 (See FIG. 3) in the electronic circuit 300 contained in the housing 302. Some of the functions of the switches 312 will be described later below.

The housing 302 also contains a display 306, which includes a UVI display area 324, a date display area 326 and a time display area 328. The display can be of any suitable type, including LCD. The UVI display area has an upper portion 322 and a lower portion 324. The lower portion 324 is adapted to display UVI in numerical form, (whereas the upper portion 322 is adapted to display UVI in graphic form, such as a “sun dot”, having ten bars, with the number of bars lit (or darkened) representing the UVI value up to 10. The bars of the “sun dot” may also be randomly lit and not represent the UVI, or may be a series of preprogrammed patterns. This way, the “sun dot” is used to make the watch display more interesting to the user and other observers. The time display area 328 is adapted to display the time. The date display area 326 is adapted to display the date and day of week, but also other parameters depending on the mode selected by the MODE or START+ buttons, as described in more detail below.

Referring again to FIG. 4, the detector 408 is positioned to face a direction that is at an angle relative to the surface of the display 406. The detector may have a direction in which the responsivity of the detector is the greatest. This is typically the case, for example, where signal-generating layer in a junction detector is generally planar and the detector does not employ other means, such as a diffuser, to eliminate directional dependency. In that case, the direction of the maximum responsivity is generally the direction perpendicular to the signal-generating layer, or the junction. In the illustrative embodiment shown in FIG. 4, the detector 408 defines a direction of maximum responsivity generally perpendicular to the face of the detector 408, and the surface of the display 406 has a general orientation that is generally perpendicular to the surface. Preferably the angle is between about 30 to 50 degrees, and more preferably about 40 degrees so that when a person in an upright posture facing the sun and wearing the monitor on his/her wrist attempts to read and adjust the settings on the monitor, the detector 408 is most likely to point approximately directly at the sun. This will most likely result in a reading of substantially the maximum UV intensity.

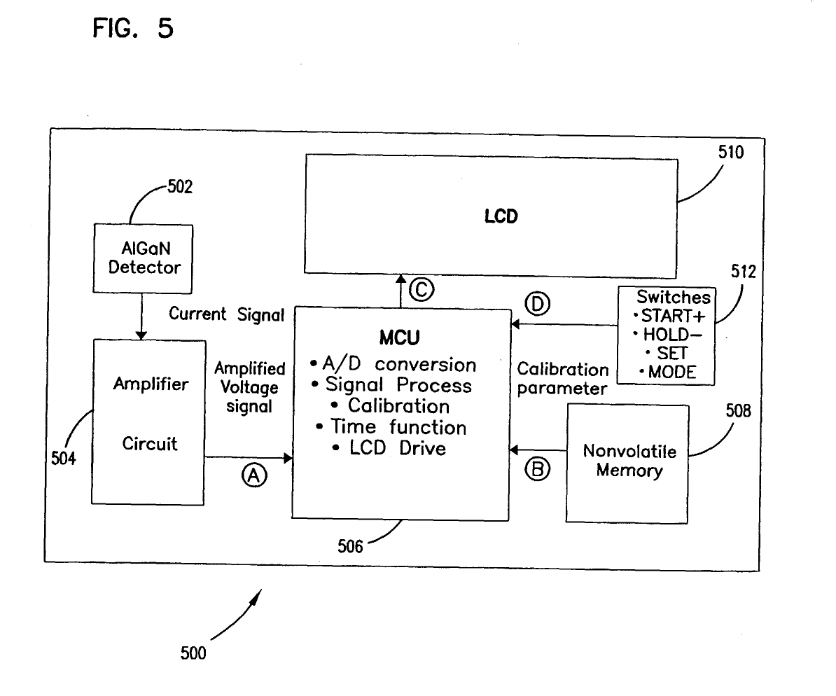

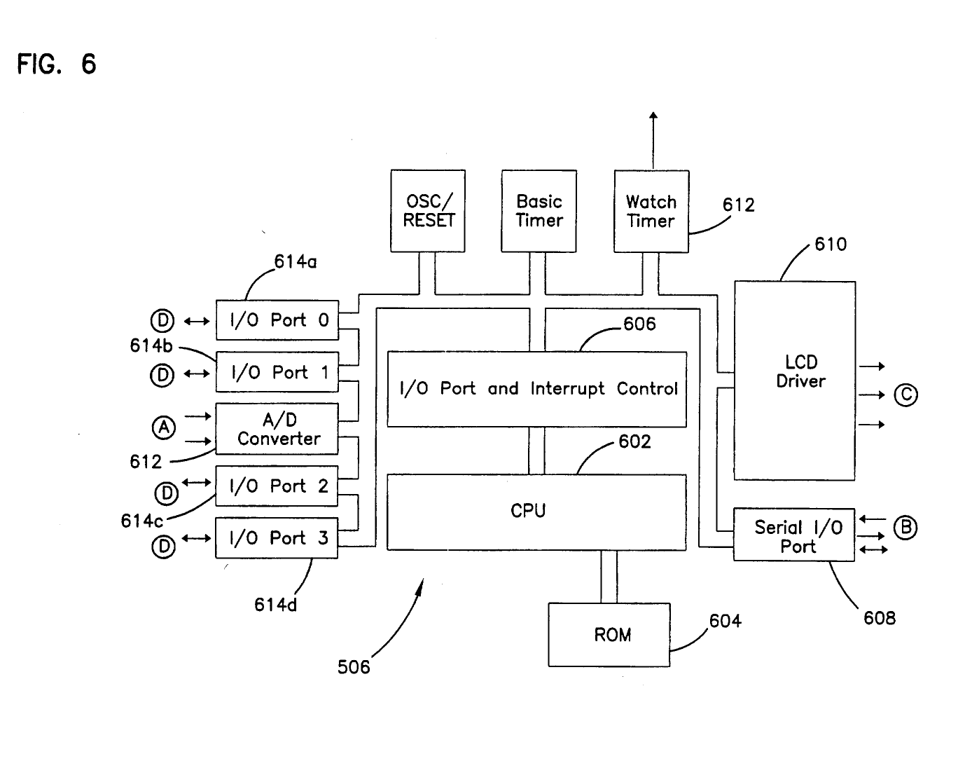

Electronically, as shown in FIG. 5, the UV monitor includes a processor 500, which includes an amplifier 504 for receiving the current signal from the UV detector 502 (the physical embodiment of which is the detector 308 in FIGS. 3 and 4) and converting the current signal to a voltage signal of a predetermined range, e.g., 0-3 volts. The processor 500 also includes a micro controller unit (“MCU”) 506, which handles all or most of the signal processing, including analog-to-digital (“A/D”) conversion, detector calibration, time calculation, display drive and other signal processing. The amplifier 504 is operatively connected to the MCU 506 and supplies voltage signal to the MCU. The processor 500 further includes a nonvolatile memory 508, such as an EEPROM, for storing the calibration parameters for the detector 502. If the relation between the detector signal amplitude and UV radiation intensity is linear, two numbers (offset and linear coefficient) can be stored in the memory 508 and read by the MCU 506. The processor further includes switches 512, which can be activated by the pushbuttons 312-318 to send signals to the MCU 506 to accomplish setting the various parameters of the UV monitor. The MCU 506 is operably connected to the display 510 for output.

The MCU 506 can be of any suitable micro-processor. Many off-the-shelf microprocessors can be used. In the embodiment illustrated in FIG. 4, the MCU 506 includes a CPU 602, the processing codes are stored in the ROM 604, connected to the CPU 602. Other parts of the MCU 606 are operably connected to the CPU 602 via the I/O port and interrupt control 606: the serial I/O port 608, which is operably connected to the nonvolatile memory 508; the LCD driver 610, which is operably connected to the display 310; watch timer 612, which supplies timing signals to the various watch functions and UV exposure time countdown; A/D converter 612, which is connected to the amplifier 504 for converting the voltage signal to a digital signal; and the I/O ports 614a-d for receiving signals generated by the switches 512, respectively.

In operation, upon receiving UV radiation, the detector 508 generates a current signal corresponding to the intensity of the radiation. The signal is converted to a voltage signal by the amplifier 504. The MCU 506 reads the voltage signal and calculates the UVI value from the magnitude of the signal and calibration parameters read from the nonvolatile memory 508. The UVI value is displayed in the UVI display area 320 as described above. In the above example of graphical representation of UVI using a “sun dot” having ten rays, the “sun dot” can be programmed to flash when UVI exceeds 10, indicating a dangerously high level of UV radiation.

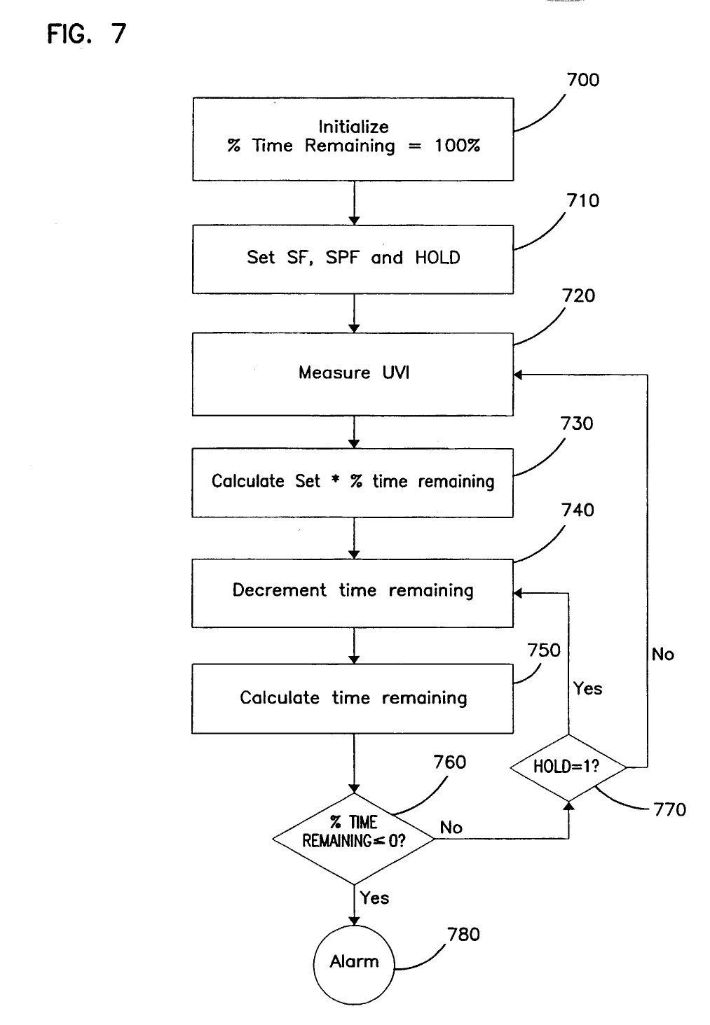

To set the safe exposure time, as outlined in FIG. 7, the user first initializes (700) the UV monitor by pressing the START+ button 312. In response, the MCU 506 sets the percentage time remaining to 100% and prompts for the user to enter the SF and SPF by incrementally changing the displayed values using the START+ (312) or HOLD− (314) buttons (710). After each value is set, the user pushes the SET button 318. Once both SF and SPF are set, the MCU 506 takes a reading of the signal from the detector 502 (720). From the signal, from which and the calibration parameters stored in the nonvolatile memory 508 the UVI can be calculated, and the SF and SPF values, the MCU 506 calculates the corresponding safe exposure time (“SE”) and multiplies it by the percentage time remaining (100% at the beginning) (730). For example, the SE can be calculated as a function of UVI, SF and SPF approximately by the equation:

$$SE ( UVI , SF , SPF ) = SE ( {UVI}_{0} , {SF}_{0} , {SPF}_{0} ) \times \frac{{UVI}_{0}}{UVI} \times {ⅇ}^{( SF - {SF}_{0} ) \times ln 1.22} \times \frac{SPF}{{SPF}_{0}} ,$$

where SE(UVI₀, SF₀, SPF₀) is the safe exposure time for a person of skin factor of SF₀, wearing a sunscreen of SPF₀, and exposed to UV radiation of UVI₀. Any SE(UVI₀, SF₀, SPF₀) can be chosen as the starting value from which other SE can be calculated. For example, one can choose SE(3, 5, 6), which is approximately one hour. Any other suitable ways to ascertain SE can also be used. For example, SE values corresponding to various combinations of SF, SPF and UVI can be pre-stored in memory and selected from based on the particular combination of SF, SPF and UVI.

The MCU 506 then lets a certain amount of time, for example 0.5 seconds, elapse (740) and calculates the percentage time remaining (750). Next the MCU 506 checks if the percentage time remaining is zero or less (760). If it is not, the MCU 506 then checks if the HOLD function, to be discussed in more detail below, is acitvated (770). If it is not, the process repeats itself beginning at step 720, i.e., a new UVI measurement is made and new SE calculated; if the HOLD function is activated, the process repeats itself beginning at step 740, i.e., more time is let pass without taking a new UVI reading.

Whenever the percentage time remaining has reached zero or negative, the MCU 506 triggers an alarm, alerting the user that the maximum safe UV exposure time has expired (780).

The HOLD function lets the user decide whether the UVI is to be assumed to be constant until the further instruction. When the user is not engaged in rigorous activities, as in the case of sunbathing, the monitor is like to be relatively steady and measure the UVI that the user is actually exposed to. In contrast, if the user is engaged in rigorous activities such as tennis playing, the position of the monitor is like to change frequently. There is then a possibility that the UV exposure measured by the monitor is substantially different from that actually experienced by most parts of the user's body if the monitor continues to update its UVI reading. To avoid this situation or to ensure a conservative setting, the user has the option to activated the HOLD function, indicating that the UVI reading is to be held constant.

The HOLD function can be activated by pressing the HOLD− button 314 for longer than a predetermined time period, for example five seconds. When the HOLD function is activated, the value of the assumed UVI is displayed in digital form in the lower portion 324 of the UVI display area 320, while the actual UVI is optionally displayed graphically in the upper portion 322.

The user can use the MODE button 316 to display the values of SF, SPF, and UVI and use the other pushbuttons 312, 314 and 318 to change any of the values.

Other processes are also possible. For example, instead of decreasing percentage time remaining from the SE, in an equivalent process, the maximum allowable UV dosage is set by the MCU 506 according to skin factor, UV dosage rate is measured as UVI reduced by a factor of SPF, and the dosage rate is integrated until the maximum allowable dosage is reached.

Other features can be added to further enhance the utility of the UV monitor. For example, the UV monitor can also be constructed to have a “Storage” mode, in which the power consumption rate by the monitor is significantly reduced. The MCU 506 can be programmed such that upon a predetermined sequence of pressing some or all of the buttons 312, 314, 316 and 318, a selected group of energy consuming components are turned off. For example, the display driver 610 and detector amplifier 504 can be powered off in this mode. The MCU 506 itself carries out no operation other than checking its own status and that of the I/O ports 614a-d every half a second or any other acceptable periodicity. If none of the buttons 312, 314, 316 and 318 has been pressed, the monitor will remain in the storage mode. If, however, any of the buttons 312, 314, 316 and 318 has been pressed, the MCU 506 sends instructions to power up all components and set the monitor in the normal operational mode.

The particular embodiments disclosed above are illustrative only, as the invention can be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above can be altered or modified and all such variations are considered within the scope and spirit of the invention. Accordingly, the protection sought herein is as set forth in the claims below.

What is claimed is:

1. An ultraviolet radiation monitor, comprising:
(a) an ultraviolet radiation detector at least partially fabricated from aluminum gallium nitride and configured to produce an intensity signal indicative of the intensity of the ultraviolet radiation received by the detector;
(b) a first signal generator configured to produce a skin type signal indicative of a level of tolerance by a person's skin to ultraviolet radiation;
(c) a second signal generator configured to produce a blocking power signal indicative of the blocking power of a sunscreen applied to the skin of the person; and
(d) a processor operatively connected to the detector, the first signal generator and the second signal generator to receive the intensity signal, skin type signal and blocking power signal,
wherein the processor is configured to generate, in response to the skin type signal and blocking power signal, a dose limit signal indicative of a limit of the cumulative ultraviolet radiation the person is to receive and, in response to the intensity signal, a cumulative dosage signal indicative of the cumulative ultraviolet radiation the person has received over a time period,
wherein the processor is further configured to produce a signal perceptible to the user when the cumulative ultraviolet radiation indicated by the dosage signal is at least the limit indicated by the dose limit signal.

2. The ultraviolet radiation monitor of claim 1, wherein the first signal generator includes a first user interface configured to receive a user input indicative of the level of tolerance by a person's skin to ultraviolet radiation, and wherein the second signal generator includes a second user interface configured to receive a user input indicative of the blocking power of the sunscreen applied to the skin of the person.

3. The ultraviolet radiation monitor of claim 2, further comprising a housing accommodating the signal generators, processor and user interfaces, wherein the housing is in the form of a wrist watch.

4. The ultraviolet radiation monitor of claim 1, wherein the magnitude of response of the detector to ultraviolet radiation changes by at least an order of 800 between 300 nm and 330 nm.

5. The ultraviolet radiation monitor of claim 4, wherein the detector has a spectral response that substantially matches the erythemal response spectrum.

6. The ultraviolet radiation monitor of claim 2, wherein the processor is configured to receive from the detector an intensity signal and to produce a dosage signal indicative of product of the intensity and the length of the time period.

7. The ultraviolet radiation monitor of claim 1, wherein the monitor further includes a substantially flat display surface configured to show a visual signal indicative of at least one of the intensity signal, skin-type signal, blocking power signal, dose limit signal and cumulative dosage signal, wherein the detector defines a direction in which the radiation flux causes the maximum response by the detector, wherein the direction is at an angle from the orientation of the display surface.

8. The ultraviolet radiation monitor of claim 1, wherein the detector is a Schottky-barrier junction detector.

9. The ultraviolet radiation monitor of claim 1, wherein the detector comprises a Schottky-barrier junction in which one electrode is made substantially of AlₓGa₁₋ₓN, wherein x is not less than about 26% and not more than about 29%.

10. A method for aiding a person to prevent over exposure to ultraviolet radiation, the method comprising:
(a) measuring the intensity of the ultraviolet radiation using an ultraviolet radiation detector at least partially fabricated from aluminum gallium nitride;
(b) ascertaining the level of tolerance by the person's skin to ultraviolet radiation;
(c) ascertaining the blocking power of any sunscreen applied to the skin of the person;
(d) deriving from the results of steps (b) and (c) a limit of the cumulative ultraviolet radiation the person is to receive;
(e) calculating, based at least partially on the ultraviolet radiation intensity measured in step (a), the cumulative ultraviolet radiation the person has received over a time period; and
(f) alerting the user when the cumulative ultraviolet radiation is at least the limit of the cumulative ultraviolet radiation the person is to receive.

11. The method of claim 10, further comprising (g) selecting, with out using spectral filters, the spectral response of the detector such that the magnitude of response of the detector to ultraviolet radiation changes by at least an order of 800 between 300 nm and 330 nm.

12. The method of claim 11, wherein (g) comprises setting the composition of the aluminum gallium nitride used in the detector, constructing the detector with a Schottky-barrier junction detector in which one electrode is made substantially of AlₓGa₁₋ₓN, wherein x is not less than about 26% and not more than about 29%.

13. The method of claim 10, further comprising the steps of:
(h) setting a percentage time value as remaining for the person to stay exposed to the ultraviolet radiation without skin damage;
(i) deriving from the results of steps (a), (b) and (c) a total amount of time, SE, the person can stay exposed to ultraviolet radiation without skin damage according to the formula
SE(UVI,SF,SPF)=SE(UVI₀,SF₀,SPF₀)×UVI₀/UVI×e^{(SF-SF}^{₀}^{)×ln 1.22}×SPF/SPF₀
where UVI is the radiation intensity, SF is the level of tolerance, quantified and skin type, by the person's skin to ultraviolet radiation, SPF is the blocking power, quantified as sun protection factor, of the sunscreen applied to the skin of the person, SE(UVI₀, SF₀, SPF₀) is a predetermined constant equal to the amount of time a person of skin factor of SF₀ and wearing a sunscreen of SPF₀ can stay exposed to ultraviolet radiation of intensity UVI₀ without skin damage;
(j) calculating the time remaining for the person to stay exposed to the ultraviolet radiation without skin damage as the result of step (i) multiplied by the percentage time value;
(k) waiting for a predetermined time interval;
(l) reducing the percentage time value by the ratio between the length of the predetermined time interval and the result of step (j);
(m) repeating steps (a) and (i) through (l) until the percentage time value is not more than a predetermined value; and
(n) alerting the user after step (m).
